(19) United States
(12) Patent Application Publication
(10) Pub. No.: US 2009/0265659 A1
(43) Pub. Date: Oct. 22, 2009

(54) MULTI-WINDOW DISPLAY CONTROL SYSTEM AND METHOD FOR PRESENTING A MULTI-WINDOW DISPLAY

(75) Inventors: CHIA-HUA CHANG, Tu-Cheng (TW); GUO-HONG HUANG, Tu-Cheng (TW); CHUI-HSIN CHIOU, Tu-Cheng (TW); CHAU-LIN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/168,514

(22) Filed: Jul. 7, 2008

(30) Foreign Application Priority Data
Apr. 22, 2008 (CN) 200810301257.5

(51) Int. Cl. G06F 3/048

(52) U.S. Cl. 715/788

(57) ABSTRACT

An exemplary multi-window display control system comprises: a read module, a display module, and a display; the method for presenting a multi-window display is also provided, the method comprising: reading the size of a display by a read module; sending the size of the display to a display module; displaying two or more display areas on a display according to a predetermined ratio; and presenting one or more functional units in each of the display area. The multi-window display control system and the method for presenting a multi-window method can provide two or more display areas on an electronic platform simultaneously, as well as provide functional unit windows in the corresponding display areas, which improve the speed and convenience of the operation.

### BACKGROUND

1. Field of the Invention

The present invention relates to a multi-window display control system and a method for presenting a multi-window display.

2. Description of Related Art

Due to the extensive requirement of human interaction with computer systems in recent years, there is a need to provide users with a convenient operation interface. Conventionally, overlapping display windows appear and allow users to perform certain operations within these windows.

However, when multiple display windows are simultaneously activated, it becomes difficult for users to see the preference content in these overlapping windows at the same time, thereby making the operation inconvenient and inefficient.

What is needed, therefore, is to provide a multi-window display control system and a method for presenting a multi-window display to increase the operability and the working efficiency in displaying multiple windows.

### BRIEF DESCRIPTION OF THE DRAWINGS

FIG. 1 is a block diagram of a multi-window display control system in accordance with an embodiment of the present invention;

FIG. 2 is a plan view showing a configuration of four display areas displaying on a display screen in accordance with an embodiment of the present invention; and

FIG. 3 is a flow chart of a method for presenting a multi-window display in accordance with an embodiment of the present invention.

### DETAILED DESCRIPTION

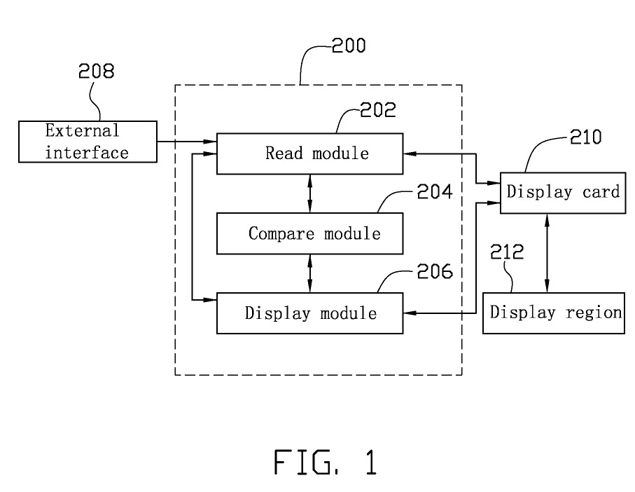

Referring to FIG. 1, a multi-window display system includes a multi-window control unit 200, an external interface 208, a display card 210, and a display region 212. The multi-window control unit 200 includes a read module 202, a compare module 204, and a display module 206. The read module 202 can obtain the size of the display region 212 via the display card 210 and can receive orders from the external interface 208. The external interface 208 can be a keyboard, a mouse or any other input device, wherein users can input orders by pressing the keyboard, clicking the mouse buttons, or dragging the mouse. If a functional unit default window needs to be displayed in the display region 212, the compare module 204 compares a size of the functional unit default window with the size of the display region 212. The display module 206 adjusts the size of the functional unit window according to the compare results and sends instructions to the display card 210 for controlling the display region 212 to display the adjusted functional unit window. The display region 212 can be the whole display screen or a display area on the display screen.

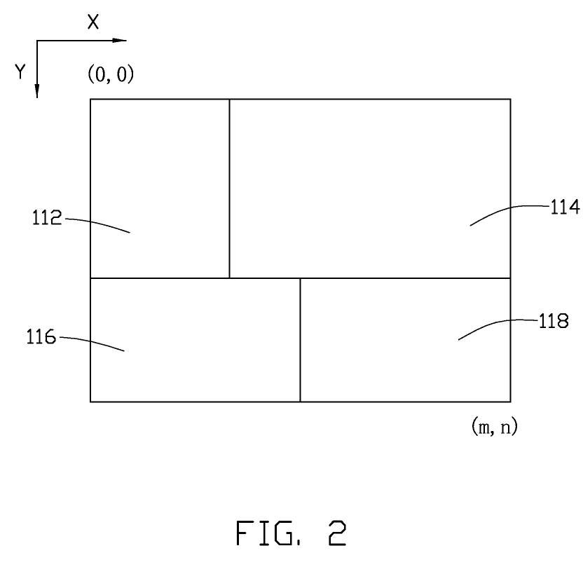

Referring to FIG. 2, a display screen 100 of the multi-window display control system is shown. In this embodiment, the display screen 100 has m pixel width and n pixel height. An X-Y coordinate system is established as shown in FIG. 2. A coordinate of an upper left corner of the display screen 100 is set to (0, 0), while a coordinate of a lower right corner of the display screen 100 is set to (m, n). According to a predetermined ratio, for example on a scale of 1:2:1:1, the display screen 100 is divided into four display areas: a first display area 112, a second display area 114, a third display area 116, and a fourth display area 118. Accordingly, coordinates of the upper left corner, the upper right corner, the lower left corner, the lower right corner of each display area 112, 114, 116, and 118 can be determined. In other embodiments, the predetermined ratio of the display areas can be altered according to the user's requirement, and the size of each display area 112, 114, 116, and 118 can be adjusted through clicking or dragging edges or corners of each display area.

Thus, the four display areas 112, 114, 116, and 118 displaying on the display screen 100 are provided to the users. Different functional units that the user wants to see can simultaneously display in the four display areas 112, 114, 116, and 118. Functional units displaying in each of the display areas are displayed by titles, symbols, or icons. When a user clicks a functional unit to activate it, the functional unit default window is displayed in the display area. The following example depicts the convenience of displaying a functional unit window in the first display area 112. Firstly, a user clicks the functional unit in the first display area 112. Next, the size of the functional unit default window is compared with the size of the first display area 112. If the two sizes are not equal, the size of the functional unit default window is adjusted to match with the size of display area 112, and the adjusted functional unit window displays in the first window 112. If the two sizes are equal, the functional unit default window displays in the display area 112.

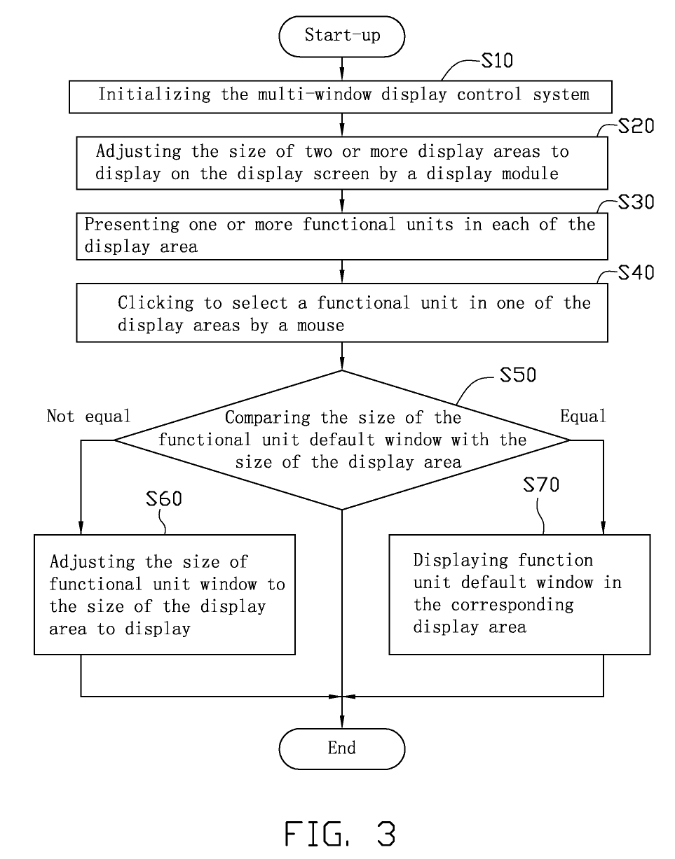

Referring to FIG. 3, a method for presenting a multi-window display includes the following steps (note that the steps are numbered in reference to FIG. 3 and are not necessarily in numerical order):

step S10, initializing the multi-window display control system.

step S20, sending the size of display screen 100 to the display module 206 by the read module 202, then adjusting the size of four display areas 112, 114, 116, and 118 to display on the display screen 100 via the display card 210 according to the predetermined ratio by the display module 206.

step S30, presenting one or more functional units in the four display areas 112, 114, 116, and 118.

step S40, sending an event of mouse clicking to select the functional unit in the first display area 112 to the read module 202 by the external interface 208.

step S50, comparing the size of the functional unit default window with the size of the display area 112 by the compare module 204.

step S60, if the size of the functional unit default window not equal to the size of the display area 112, adjusting the size of functional unit window to the same size as the display area to display in the first display area 112 by the display module 206; and

step S70, if the size of the functional unit default window and the size of the display area equal, displaying the functional unit default window in the display area 112 via the display card 210 by the display module 206.

If another functional unit window needs to be displayed in the display area 114, 116 or 118, the user can click a functional unit in the corresponding display area and repeat steps S40-S70.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for presenting a multi-window display, the method comprising:
reading the size of a display by a read module;
sending the size of the display to a display module;
displaying two or more display areas on the display according to a predetermined ratio; and
presenting one or more functional units in each of the display area.

2. The method as claimed in claim 1, further comprising: activating a functional unit in one of the display areas, activating is performed by inputs from an external interface.

3. The method as claimed in claim 1, further comprising: comparing a size of an activated functional unit default window with the size of the display area and transmitting the compare result to the display module by a compare module;
Upon the condition that both sizes not equal, adjusting the size of the functional unit window to the same size as the display area to display in the display area by the display module.

4. The method as claimed in claim 1, wherein at least one of the functional units are different from the others in each display area.

5. The method as claimed in claim 1, wherein when presenting, at least two of the functional units are the same in each display area.

6. A multi-window display control system, the control system comprising:
a read module, a display module, and a display;
the read module is capable of determining the size of the display and sending the size to the display module; and
the display module is capable of displaying two or more display areas on the display according to a predetermined ratio and one or more functional units in each of the display areas.

7. The control system as claimed in claim 6, further comprising an external interface, the external interface is capable of receiving input orders from external devices to activate functional units in each of the display areas.

8. The control system as claimed in claim 6, further comprising a compare module, the compare module is capable of comparing a size of an activated functional unit default window with the size of the display area and transmitting the compare result to the display module;
Upon the condition that both sizes are not equal, the display module is capable of adjusting the size of the functional unit window to the same size as the display area to display in the display area.

9. The control system as claimed in claim 6, wherein at least two of the functional units are the same in each display area.

10. The control system as claimed in claim 6, wherein when presenting, at least one of the functional units are different from the others in each display area.
